(19) United States
(12) Patent Application Publication
(10) Pub. No.: US 2014/0071607 A1
(43) Pub. Date: Mar. 13, 2014

(54) CASE AND KEYBOARD FOR A PORTABLE ELECTRONIC DEVICE

(71) Applicant: Targus Group International, Inc., Anaheim, CA (US)

(72) Inventors: James Christian Frinak, Los Angeles, CA (US); Katrina Huang, Hacienda Heights, CA (US); Alice MC Lee, Fullerton, CA (US); Craig Ian Reiser, Long Beach, CA (US)

(73) Assignee: Targus Group International, Inc., Anaheim, CA (US)

(21) Appl. No.: 14/020,298

(22) Filed: Sep. 6, 2013

Related U.S. Application Data
(60) Provisional application No. 61/698,158, filed on Sep. 7, 2012.

(51) Int. Cl. G06F 1/16

(52) U.S. Cl. CPC G06F 1/1624
USPC 361/679.09; 206/736

(57) ABSTRACT

A case for a portable electronic device (PED) may include a keyboard, a base, and a support. The keyboard includes a receiving surface configured to support an edge of the PED. The base is configured to slidably engage the keyboard and the keyboard is removable from the base. The support is coupled to the base and includes a support surface for supporting the PED in an elevated position. The support is pivotable relative to the base and allows the PED to pivot relative to the support between a collapsed position and an elevated position. The angle of the PED supported by the receiving surface and the support surface is changed as the keyboard is slid relative to the base such that the angle of the PED with respect to the base is changed.

### RELATED APPLICATIONS

This application claims the benefit under 35 U.S.C. §119(e) of U.S. Provisional Application No. 61/698,158, filed Sep. 7, 2012, which is incorporated by reference herein in its entirety.

### TECHNICAL FIELD

The present disclosure relates generally to portable electronic devices and, more specifically, to case accessories for portable electronic devices.

### BRIEF DESCRIPTION OF THE DRAWINGS

FIG. 1 is a perspective view illustrating one embodiment of a case, portable electronic device (PED), and keyboard, according to one embodiment.

FIG. 2 is a perspective view of a case supporting a PED in an elevated position, according to one embodiment.

FIG. 3 is a perspective view of a case supporting a PED in an elevated position with a different viewing angle, according to one embodiment.

FIG. 4 is a perspective view of a case supporting a PED in an elevated position with the PED resting on the base, according to one embodiment.

FIG. 5 is a perspective view of a case supporting a PED in an elevated position with the keyboard removed, according to one embodiment.

FIG. 6 is a perspective view from the rear of a case supporting a PED in an elevated position, according to one embodiment.

FIG. 7 is a perspective of a case in a closed position, according to one embodiment.

### DESCRIPTION

The proliferation of portable electronic devices (PEDs), including notebook and tablet computers (e.g., the Apple® iPad™), portable digital assistants (PDAs), and smartphones, has placed more computing power into the hands of users than the computing power of early computers that occupied an entire room. This portable computing power has enhanced both personal and business mobile productivity.

However, there are a number of potential disadvantages with such compact devices. For example, PEDs may be susceptible to damage due to their portable nature and because they are often carried or used in locations where extreme temperatures, dust or other particles, vibration, or physical impact is likely. Another disadvantage, due to their compact style, is reduced efficiency for users to enter text or other information into such compact devices. Yet another disadvantage is that users' arms or wrists may tire after long use and the PEDs may be difficult to prop up for viewing or to position at a desired angle.

Embodiments of the present disclosure provide an accessory case for a PED configured to protect the PED from damage. In some embodiments, the accessory case is configured to substantially enclose the PED and slidably support a keyboard. In various embodiments, the case may be configured to selectively substantially enclose and protect the PED in a closed position and support the PED upright and/or elevated (i.e., propped up) in an open position. In some embodiments, a viewing angle of the PED in an elevated position may be adjusted by sliding a keyboard or other slide member relative to the case.

Embodiments may be best understood by reference to the drawings. In certain instances, like features may be designated with like reference numerals. It will be readily understood that the components of the present disclosure, as generally described and illustrated in the drawings herein, could be arranged and designed in a wide variety of configurations. Thus, the following more detailed description of the embodiments of the apparatus is not intended to limit the scope of the disclosure, but is merely representative of possible embodiments of the disclosure. In some cases, well-known structures, materials, or operations are not shown or described in detail.

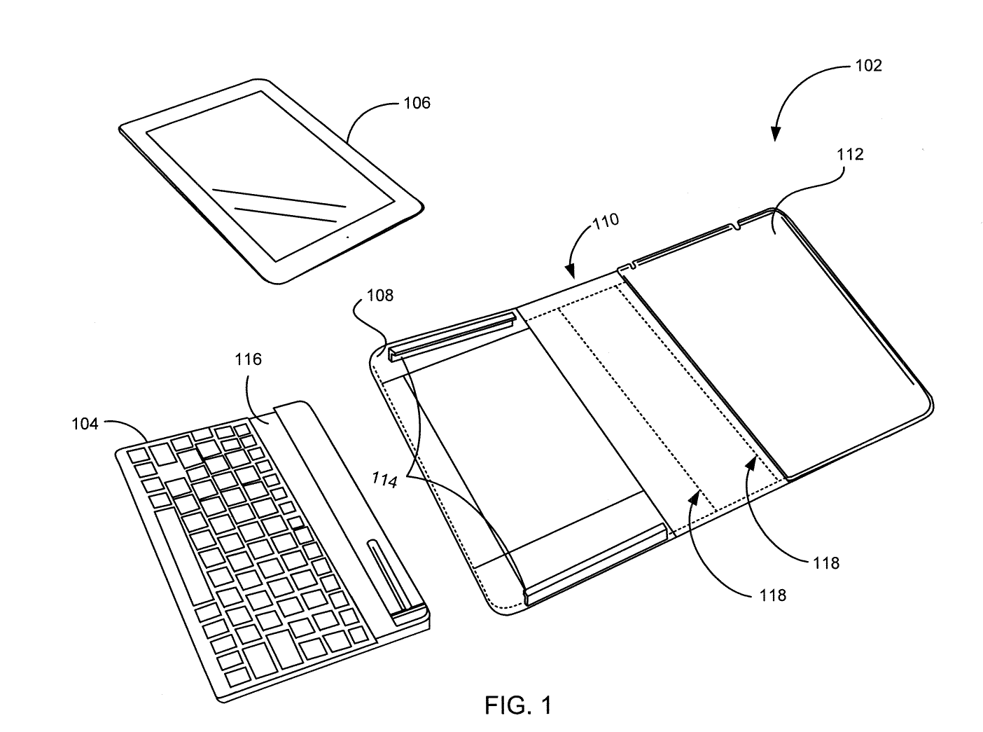

FIG. 1 is a perspective view illustrating one embodiment of a case 102, keyboard 104, and PED 106. The case 102 is shown in an open position with the keyboard 104 and PED 106 separate from the case 102. The case 102 may be configured to connect to and/or retain the keyboard 104 and PED 106 in or on the case 102. The case 102 may selectively serve as a protective cover for the PED 106 and as a stand to support the PED 106 in an elevated position. The case 102 may also serve to support and retain the keyboard 104 on the case 102 for entering data into the PED 106. In the depicted embodiment, the case 102 includes a base 108, a support panel 110, and a retention panel 112.

In one embodiment, the base 108 is configured to retain the keyboard 104 on the base 108. In one embodiment, the base 108 slidably engages the keyboard 104. For example, the base 108 may include guide rails 114 for slidably receiving the keyboard 104. In the depicted embodiment, the guide rails 114 protrude from the base 108 and are configured to engage an edge or a bottom of the keyboard 104. For example, the keyboard 104 may include grooves, slots, or other structures (not shown) corresponding to the guide rails 114 and configured to receive the guide rails 114. The guide rails 114 depicted in FIG. 1 are given by way of example only and may include one or more protrusions or depressions for engaging the keyboard 104 in a slidable manner.

The guide rails 114 may include a cross-sectional shape to allow grooves, slots, or other corresponding features of the keyboard 104 to slide over the guide rails 114 or between the guide rails 114, but limit movement in other directions, such as laterally or vertically in a direction perpendicular to the length of the guide rails 114.

The interface between the guide rails 114 and keyboard 104 may be low friction and allow for easy sliding of the keyboard relative to the base 108. A small amount of friction may be present between the guide rails 114 and keyboard 104, which may help the keyboard 104 remain in a desired position. For example, a sufficient amount of friction may be present to allow the keyboard to support the PED 106 and/or retention panel 112 in an elevated position. In one embodiment, the keyboard 104 is selectively removable or mountable on the guide rails 114, which may allow a user to position the keyboard 104 with the base or separately from the case 102 as needed for typing. For example, the keyboard 104 or other slide member may be removable from the rails by sliding the keyboard 104 or other slide member off an end of the rails.

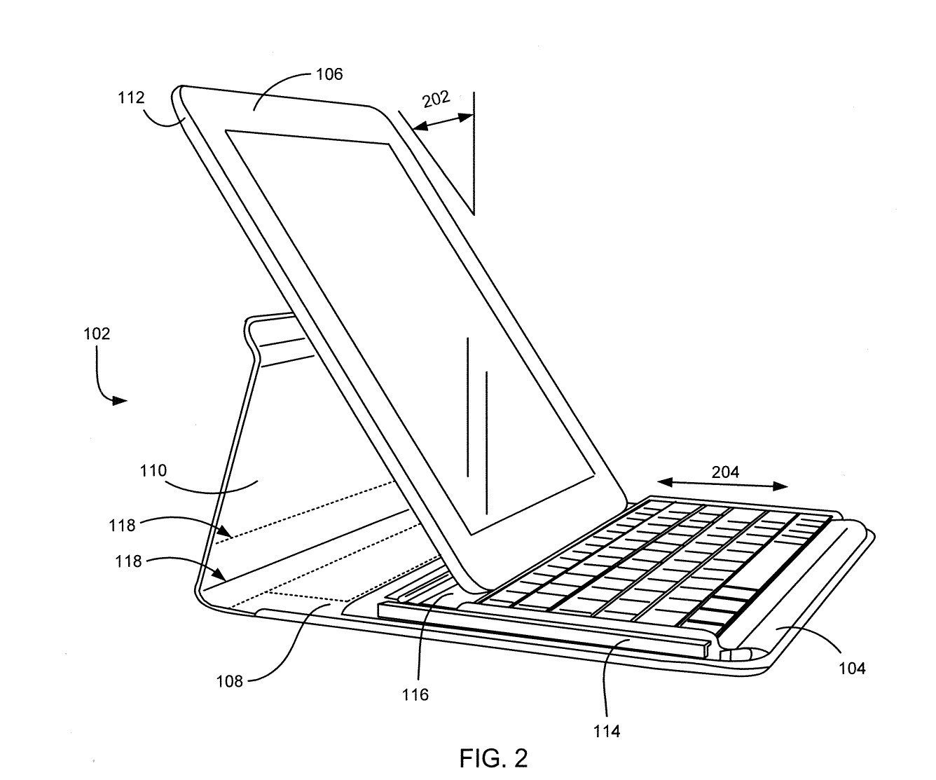

According to one embodiment, the base 108 is configured to rest on a surface and support the retention panel 112 and/or PED 106 in an elevated position. For example, the base 108 may rest on a table, desk or other surface and support the PED 106 at a vertical angle for viewing. See FIGS. 2-6 which are discussed further below.

The keyboard 104 may be configured to communicate with the PED 106. The keyboard 104 may communicate with the PED 106 in a wireless or wired manner. For example, the keyboard 104 may be configured to communicate with the PED 106 using the Bluetooth communications standard or 802.11 (WiFi) communication standard. Any other communication standard or method of communication with the PED 106 may be used without limitation including via wired or physical connections. In one embodiment, a user may be able to type on the keyboard 104 to enter text, data, or other input into the PED 106. Data entry using a keyboard 104 may be quicker and/or more desirable to some users. For example, a user may find it more efficient to use the keyboard 104 while entering text, editing a document, or the like. Similarly, the keyboard 104 may be used for navigation within software of the PED 106.

The keyboard 104 includes a PED receiving surface 116. The PED receiving surface 116 may provide a surface on which to rest an edge of the PED 106 and/or retention panel 112. The PED receiving surface 116 may be high friction or may include physical structure that limits an edge of a PED 106 or retention panel 112 from sliding relative to the PED receiving surface 116. For example, the PED receiving surface 116 may include ridges, rubber, or other structure or feature that limits movement of an edge of the PED 106 in a direction parallel to the guide rails 114. In the depicted embodiment, the PED receiving surface 116 is within a groove on top of the keyboard 104. The walls of the groove may keep a PED 106 or retention panel 112 in place.

In one embodiment, the base 108 may slidably engage a slide member in place of the keyboard 104. For example, the slide member may include a panel or other member configured to engage the guide rails 114 of the base 108. In one embodiment, the slide member includes a PED receiving surface 116 such as the PED receiving surface 116 of FIG. 1. In one embodiment, the slide member is configured to receive a keyboard 104 to be held by the slide member. For example, the slide member may include a frame where a keyboard 104 may be inserted and/or engaged by the slide member. In one embodiment, the slide member with keyboard 104 may be configured to operate similarly to the keyboard 104 depicted in FIGS. 1 and 2. However, the keyboard 104 may be swapped out without affecting the functionality of the slide member. In one embodiment, the keyboard 104 of FIG. 1 includes a slide member with a keyboard coupled to it. For example, the keyboard 104 may be removed to leave a slide member that includes a frame that is configured to engage the guide rails 114 and also includes the receiving surface 116.

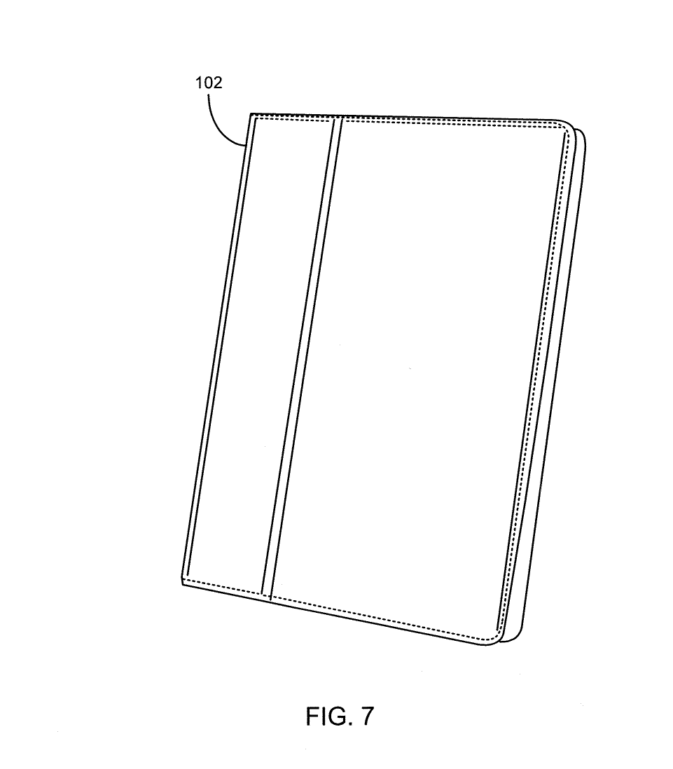

The support panel 110 may serve as a support to retention panel 112 to support the retention panel 112 and/or the PED 106 in an elevated position. The support panel 110 may include joints that allow pivoting of the support panel 110 relative to the base 108 and/or retention panel 112. For example, the case may be bendable at joints 118, which may allow for the retention panel 112 to pivot from a flat position (as shown in FIG. 1) or a book position (as shown in FIG. 7) to an elevated position (as shown in FIGS. 2-6). The support panel 110 is exemplary only and may be replaced by one or more arms, joints, or any other material or structure that can be used as a support member to support the retention panel 112 and/or PED 106.

In one embodiment, a support, base, and retention mechanisms are in panel form (as depicted with the case 102 of FIG. 1 including a base 108 panel, a support panel 110, and a retention panel 112). In one embodiment, panel forms for the base, support, and retention mechanism may result in a case 102 that can serve to selectively support a PED 106 as well as protect the PED 106 because substantially all surfaces of the PED 106 may be protected by the case 102 when in a collapsed position.

In one embodiment, the support panel 110, or other support member may pivot with respect to the base between a collapsed position and an extended position. In one embodiment, with the support panel 110 in a collapsed position, the PED 106 is substantially enclosed by the case 102 as depicted in FIG. 7. The support panel 110 may serve to selectively support the PED 106 in an elevated position or in a closed position. For example, when in a collapsed position, a screen of the PED 106 may be covered or otherwise protected by the base 108, keyboard 104, or other portion of the case.

In one embodiment, the support panel 110 includes a support surface for supporting the PED 106 in an elevated position. For example, the support surface may contact, connect to, or otherwise engage the PED 106 to hold the PED 106 in a position at least partially transverse to a horizontal base 108 and/or keyboard 104. In one embodiment, the support surface includes a securing mechanism to secure the PED 106 to the support panel 110 or other support member. For example, the securing mechanism may engage one or more edges or a connector interface of the PED 106 to secure the PED to or within the case 102. In one embodiment, the securing mechanism includes the retention panel 112.

The support panel 110 may be formed of a variety of materials which provide structure and/or a pleasing texture and appearance. For example, the support panel 110 may include rigid materials, such as plastic, rubber, metal, or other material. The support panel 110 may also include a material covering rigid materials, such as fabric, plastic, rubber, metal, leather, faux leather, vinyl, nylon, and/or any of a wide variety of decorative or useful materials utilized in cases, bags, luggage, and the like.

The retention panel 112 may be configured to retain the PED 106 on or in the case 102. For example, the depicted retention panel 112 includes a shape matching the edges of the PED 106 to hold the PED 106 within the retention panel 112. The PED 106 may be snapped in or otherwise positioned with the retention panel 112 and the retention panel may retain the PED 106 in place. The retention panel 112 is given by way of example only. Any other type of retention panel or mechanism may be used. For example the retention panel 112 may be replaced with a sleeve with a see-through or open side so that the screen of the PED 106 is visible. As another example, a connector configured to connect to a connector or one or more edges of the PED 106 may be used in place of the retention panel 112 without limitation. As yet another example, glue, snap-on connectors, or any other connector may be used to permanently or removably secure the PED 106.

The retention panel 112 may be formed of a variety of materials. For example, the retention panel 112 may include fabric, plastic, rubber, metal, leather, faux leather, vinyl, nylon, and/or any of a wide variety of decorative or useful materials utilized in cases, bags, luggage, and the like.

The PED 106 may be any portable electronic device including, for example, a notebook computer, an electronic book reader (e.g., the Amazon® Kindle™), a smartphone (e.g., the Apple® iPhone™, the Motorola® Droid®, and the BlackBerry® Storm™), and/or a tablet computer (e.g., the Apple® iPad™, the HP® Slate, and the Samsung® Galaxy™ Tablet). As will be understood by one skilled in the art, various dimensions and/or proportions of the case 102 and/or keyboard 104 may be modified to fit a specific PED. For example, a case 102 for one type of PED may have different dimensions and/or proportions as compared to a case 102 for another type of PED.

FIG. 2 is a perspective view of a case 102 supporting the PED 106 in an elevated position. The keyboard 104 is shown mounted on the base 108 between guide rails 114 (engaging opposite edges of the keyboard 104) and the support panel 110 is shown in an elevated position supporting the retaining panel 112 and PED 106. The support panel 110 is shown flexing at one of the joints 118 while the other is substantially straight. The PED 106 and retaining panel 112 are shown resting on the PED receiving surface 116 of the keyboard 104 or other support member.

The PED 106 is shown elevated at a viewing angle 202. A user may type on the keyboard 104 while the keyboard 104, base 108, and support panel 110 support the PED 106 at an angle convenient for viewing. According to one embodiment, the viewing angle 202 may be changed by sliding the keyboard 104 in the directions indicated by arrow 204 relative to the base 108 and/or guide rails 114. For example, to increase the viewing angle 202 the keyboard 104 may be slid outwardly from the case 102 and the PED 106 will tilt to a more horizontal position or angle. Thus, in one embodiment, an angle of the PED 106 may be changed by sliding the keyboard 104 or a slide member relative to the base 108.

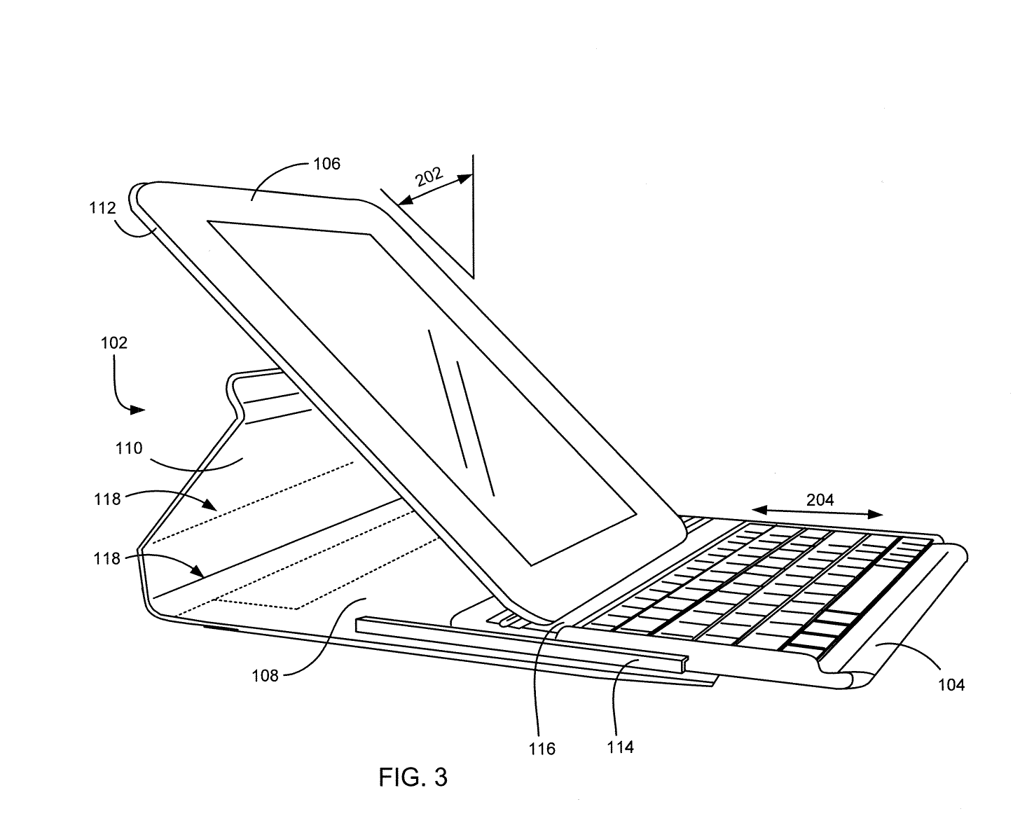

FIG. 3 is a perspective view of the case 102 supporting the PED 106 in an elevated position similar to FIG. 2. However, the keyboard 104 has been slid outward from the base 108 and guide rails 114 as compared to the position of FIG. 2, which has allowed the PED 106 to tilt backwards to increase the viewing angle 202. The keyboard 104 or other slide member is still at least partially engaged by the guide rails 114 which may allow the keyboard 104 to remain in place. A small amount of friction between the keyboard 104 and the base 108 or guide rails 114 may allow the viewing angle 202 to be maintained under the weight of the PED 106. An edge of the PED 106 is shown resting on the PED receiving surface 116 of the keyboard 104 which may allow the PED 106 to remain in place and not slide relative to the keyboard 104 and/or base 108.

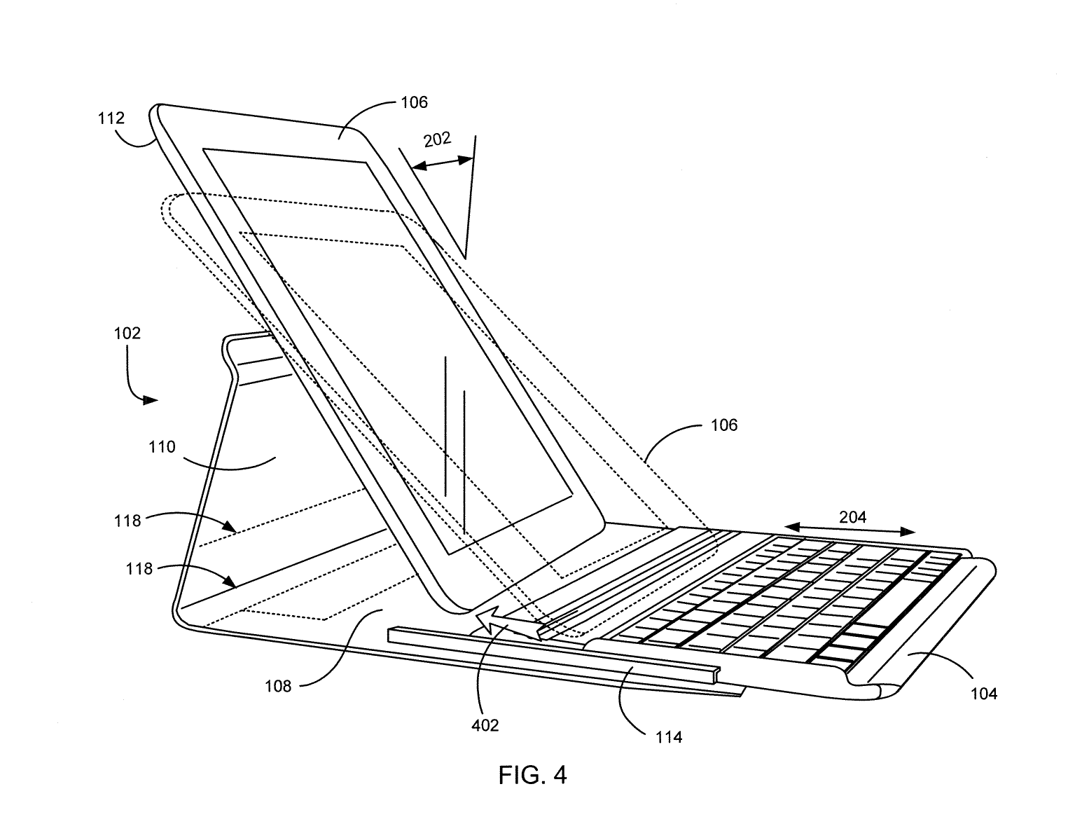

FIG. 4 illustrates a perspective view of the case 102 with the PED 106 resting on a surface of the base 108, rather than the PED receiving surface 116 of the keyboard 104. The keyboard 104 is in the same position as that depicted in FIG. 3, but an edge of the PED 106 has been moved as depicted by arrow 402 to rest on the base 108 rather than the PED receiving surface 116 of the keyboard 104.

In one embodiment, the base 108 includes a surface that provides friction between the PED 106 and/or retention panel 112 so that the PED 106 is maintained in a stable position. For example, an internal surface of the base 108 may be formed of rubber, suede leather, faux suede, or a rigid material with a structure that provides resistance to sliding of the PED 106 or retention panel 112. Resting the PED 106 on the base 108 rather than the keyboard 104 may allow a user the freedom to move the keyboard 104 without altering the viewing angle 202 of the PED 106. For example, it may be desirable to a user to slide the keyboard farther away from the PED 106 without changing the viewing angle 202 of the PED 106. In the case where a slide member is used, the keyboard 104 may be removed from the slide member while still allowing an edge of the PED 106 to remain on the PED receiving surface 116.

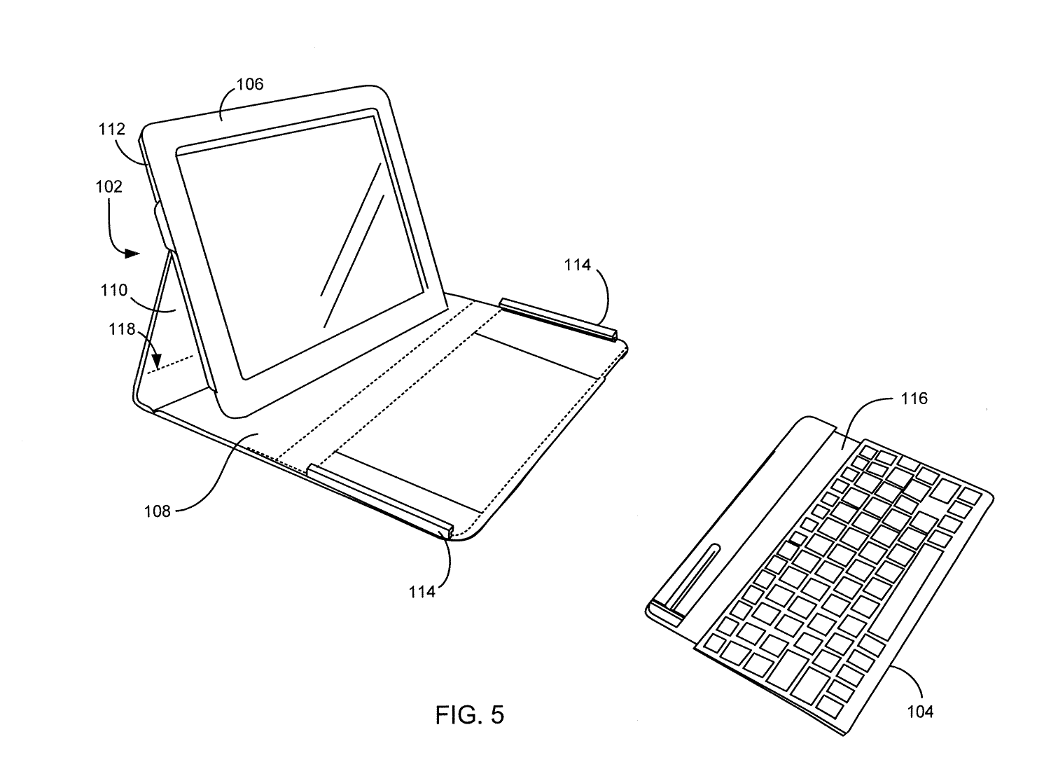

FIG. 5 illustrates a perspective view of a case 102 supporting the PED 106 in an elevated position and with the keyboard 104 removed. The case 102 is similar to the cases of the previous figures except for the guide rails 114. The keyboard 104 is shown dismounted from the guide rails 114 of the case 102, which may allow a user to use the case 102 similar to a monitor stand to hold the PED 106, while the keyboard 104 can be placed in any desired location. Flexibility in the placement of the keyboard 104 may allow for reduced use injuries (e.g., carpal tunnel) common with typing or other data entry because a user may be more free to move the keyboard 104 while typing or providing input to the PED 106.

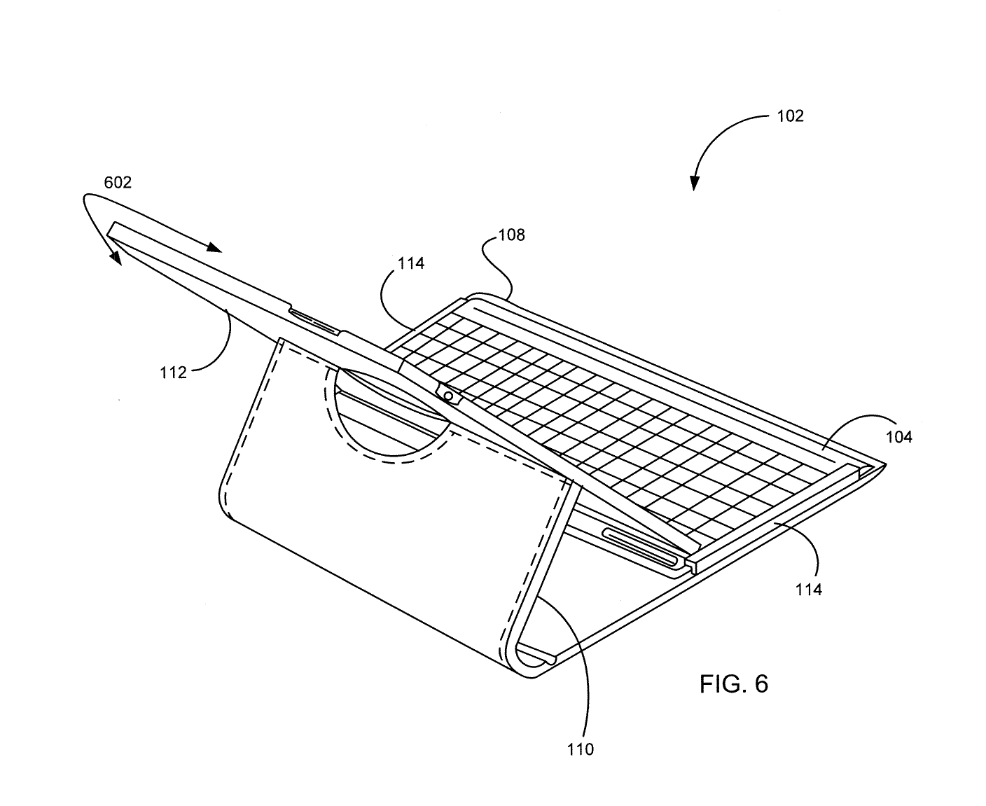

FIG. 6 illustrates a perspective view from the rear and side of a case 102 illustrating one embodiment of the structure of the support panel 110. The guide rails 114 are shown engaging opposite edges of the keyboard 104 to hold it in place. In one embodiment, the support panel 110 allows the retention panel 112 and/or PED 106 to rotate relative to the support panel 110 and base 108, as depicted by arrow 602, such that a screen of the PED 106 can be selectively in portrait or landscape modes. For example, a rotatable joint, pivot, or other mechanism may connect the support panel 110 to the retention panel 112 to allow the two to rotate with respect to each other. One of skill in the art will recognize numerous connection mechanisms that will allow the retention panel 112 and/or PED 106 to rotate with respect to the support panel 110 while remaining secured to the case 102. Additional example embodiments of rotatable joints, pivots, or other rotation mechanisms to allow rotation of the PED 106 with respect to the base 108 and/or support panel 110 are illustrated in U.S. Patent Publication No. 2011/0297566 A1, which is herein incorporated by reference in its entirety.

FIG. 7 illustrates the case 102 in a closed position. The case 102 is shown folded at joints 118 (see FIG. 1) to form a book-style carrying case. The PED 106 and/or keyboard 104 may be enclosed within the case 102 and be protected from damage. The case 102 in a closed position may form a compact and/or stylish carrying case for the PED 106. The exterior of the case 102 may be formed of a variety of materials. For example, the case 102 exterior may include various materials, such as fabric, plastic, rubber, metal, leather, faux leather, vinyl, nylon, and/or any of a wide variety of decorative or useful materials utilized in cases, bags, luggage, and the like.

This disclosure has been made with reference to various exemplary embodiments, including the best mode. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the following claims.

What is claimed is:

1. A case for a portable electronic device (PED) comprising:
a keyboard comprising a receiving surface to support an edge of the PED;
a base slidably engaging the keyboard, wherein the keyboard is removable from the base; and
a support coupled to the base, the support comprising a support surface for supporting the PED in an elevated position, wherein the support is pivotable relative to the base,
wherein an angle of the PED supported by the receiving surface and the support surface is changed as the keyboard is slid relative to the base.

2. The case of claim 1, wherein the base comprises guide rails and wherein the guide rails slidably engage the keyboard.

3. The case of claim 2, wherein the keyboard is removable from the base by sliding the keyboard off an end of the guide rails.

4. The case of claim 1, wherein the base slidably engages the keyboard with sufficient friction to support the PED in the elevated position without allowing the keyboard to slide relative to the base.

5. The case of claim 1, wherein the support is pivotable with respect to the base to selectively position the support at a collapsed position and an extended position.

6. The case of claim 5, wherein with the support in the collapsed position, a screen of the PED is substantially covered by the case.

7. The case of claim 5, wherein with the support in the collapsed position, the PED is substantially enclosed within the case.

8. The case of claim 5, wherein with the support in the extended position, the PED is supported in the elevated position.

9. The case of claim 1, wherein the receiving surface comprises a first receiving surface and wherein the base comprises a second receiving surface for supporting the edge of the PED.

10. The case of claim 9, wherein the second receiving surface is at least partially covered by the keyboard wherein the keyboard is secured to the base and in a closed position.

11. The case of claim 1, wherein the support surface comprises a retention panel configured to secure the PED to the support.

12. A case for a portable electronic device (PED) comprising:
a slide member comprising a receiving surface configured to support an edge of the PED;
a base slidably supporting the slide member; and
a support member configured to support the PED relative to the base, wherein the support member is pivotable relative to the base between a collapsed position and an extended position,
wherein an angle of a PED supported by the receiving surface and the support member is changed as the slide member is slid relative to the base.

13. The case of claim 12, wherein the slide member is further configured to selectively receive a keyboard.

14. The case of claim 12, further comprising a securing mechanism to secure the PED to the support member.

15. The case of claim 14, wherein the securing mechanism engages one or more edges of the PED.

16. The case of claim 15, wherein the securing mechanism comprises a retention panel.

17. The case of claim 14, wherein the securing mechanism pivotably secures the PED to the support member, wherein the PED is rotatable between a landscape orientation and a portrait orientation.

18. An apparatus comprising:
a retention panel configured to secure a portable electronic device (PED);
a keyboard comprising a receiving surface configured to support an edge of the retention panel;
a base panel comprising guide rails, the guide rails slidably engaging the keyboard; and
a support panel coupled to the base panel and the retention panel, wherein the support panel selectively supports the retention panel relative to the base in an elevated position; and
wherein, with the retention panel in an elevated position and the receiving surface supporting an edge of the retention panel, an angle of the retention panel in the elevated position is changed as the keyboard is slid relative to the base.

19. The apparatus of claim 18, wherein the keyboard is detachable from the base.

20. The apparatus of claim 18, wherein the retention panel is rotatable with respect to the support panel.
